(19) United States
(12) Patent Application Publication
(10) Pub. No.: US 2010/0118286 A1
(43) Pub. Date: May 13, 2010

(54) EXPOSURE APPARATUS AND DEVICE MANUFACTURING METHOD

(75) Inventor: Hisashi Namba, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/617,644

(22) Filed: Nov. 12, 2009

(30) Foreign Application Priority Data
Nov. 13, 2008 (JP) 2008-291104

(51) Int. Cl. G03B 27/52

(52) U.S. Cl. 355/30

(57) ABSTRACT

An exposure apparatus exposes a substrate to light via an immersion liquid and includes a stage configured to hold the substrate and to be moved. The stage includes a chuck configured to hold the substrate, a support member arranged around the chuck and configured to support the immersion liquid, a recovery path configured to recover the immersion liquid having entered a gap between the substrate and the support member, and a temperature-regulating path through which the temperature-regulated liquid flows. The temperature-regulating path is connected with the recovery path.

### BACKGROUND OF THE INVENTION

1. Field of the Invention

The present invention relates to an exposure apparatus for exposing a substrate to light via an immersion liquid, and a device manufacturing method.

2. Description of the Related Art

Recently, an immersion exposure apparatus exposing a wafer to light via an immersion liquid has been developed. A conventional immersion exposure apparatus 200 will be described with reference to FIG. 10. FIG. 10 is a schematic diagram illustrating a conventional immersion exposure apparatus.

The immersion exposure apparatus 200 includes an illumination device 1, a reticle stage 3, a projection optical system 4, a wafer stage 70, and a nozzle unit 11.

The illumination device 1 illuminates a reticle 2. The reticle stage 3 holds the reticle 2, and can move. The projection optical system 4 projects a pattern of the reticle 2, which is illuminated by the illumination device 1, on a wafer 5. The wafer stage 70 holds the wafer 5 by a chuck 6, and can move.

The nozzle unit 11 includes a supply port and a recovery port. The supply port supplies an immersion liquid 12 to between the projection optical system 4 and the wafer 5. The recovery port recovers the immersion liquid 12 from between the projection optical system 4 and the wafer 5. The supply port is connected with a supply pipe 13, and the recovery port is connected with a recovery pipe 14.

The wafer stage 70 includes an support plate 121. The support plate 121 is placed around the wafer chuck 6. The surface of the support plate 121 is set at approximately the same height as a surface of the wafer 5 held by the wafer chuck 6.

A gap is formed between the support plate 121 and the wafer 5. When an edge shot of the wafer 5 is exposed to light, the immersion liquid 12 exists on the gap, and thus enters the gap.

The immersion liquid 12 having entered the gap pools in the gap if nothing is done. The pooled immersion liquid 12 could be scattered on the wafer 5 or on the support plate 121 when the wafer stage 70 moves.

When the immersion liquid 12 remaining on the wafer 5 or the support plate 121 evaporates, the wafer 5 or the support plate 121 is deformed by the vaporization heat, and a water mark is thus formed on the wafer 5 or on the support plate 121.

Therefore, the immersion illiquid 12 pooled in the gap between the support plate 121 and the wafer 5 is conventionally sucked and recovered through a recovery path.

However, when the immersion liquid 12 pooled in the gap is sucked and recovered, the immersion liquid 12 can evaporate in the recovery path, and the temperature of the support plate 121 can be lowered by the vaporization heat generated when the immersion liquid 12 is evaporated. When the temperature of the support plate 121 lowers, the temperatures of other members of the wafer stage 70 also lower. As a result, the wafer stage 70 is deformed, and the positioning precision the wafer stage 70 lowers.

Japanese Patent Application Laid-Open No. 2007-194618 discusses that the support plate 121 includes a temperature-regulating path for preventing the lowering of the temperature of the support plate 121.

Japanese Patent Application Laid-Open No. 2006-313910 discusses an immersion exposure apparatus, which supplies a liquid into the gap between the wafer 5 and the support plate 121 for removing bubbles. The pamphlet of International Publication No. 2006/112436 discusses an exposure apparatus in which a temperature-regulating liquid is supplied into the nozzle unit 11 for preventing the effect of the vaporization heat in a recovery path of the nozzle unit 11.

In Japanese Patent Application Laid-Open No. 2007-194618, only the temperature of the support plate 121 is regulated. However, the recovery path passes through not only the support plate 121 but also other members of the wafer stage 70. Therefore, in addition to the temperature of the support plate 121, the temperatures of other members of the wafer stage 70 need to be regulated to suppress the lowering the temperature of the wafer stage 70.

### SUMMARY OF THE INVENTION

The present invention is directed to an exposure apparatus advantageous in a stability of temperature of a stage including a recovery path of an immersion liquid.

According to an aspect of the present invention, an exposure apparatus for exposing a substrate to light via an immersion liquid includes a stage configured to hold the substrate and to be moved, and the stage includes a chuck configured to hold the substrate, a support member arranged around the chuck, and configured to support the immersion liquid, a recovery path configured to recover the immersion liquid having entered a gap between the substrate and the support member, and a temperature-regulating path through which a temperature-regulated liquid flows, wherein the temperature-regulating path is connected with the recovery path. The above aspect of the present invention can provide, for example, an exposure apparatus advantageous in a stability of temperature of a stage including a recovery path of an immersion liquid.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a cross-sectional view of a wafer stage according to a first exemplary embodiment of the present invention.

FIG. 2 is a top view of a wafer stage according to the first exemplary embodiment of the present invention.

FIG. 3 is a cross-sectional view of a wafer stage according to a second exemplary embodiment of the present invention.

FIG. 4 is a top view of a wafer stage according to the second exemplary embodiment of the present invention.

FIG. 5 is a cross-sectional view of a wafer stage according to a third exemplary embodiment of the present invention.

FIG. 6 is a top view of a wafer stage according to the third exemplary embodiment of the present invention.

FIG. 7 is a schematic diagram illustrating an example of an exposure apparatus according to an exemplary embodiment of the present invention.

FIG. 8 is a cross-sectional view of a wafer stage according to a fourth exemplary embodiment of the present invention.

FIG. 9 is a top view of a wafer stage according to a fifth exemplary embodiment of the present invention.

FIG. 10 is a schematic diagram of a conventional exposure apparatus.

### DESCRIPTION OF THE EMBODIMENTS

Various exemplary embodiments, features, and aspects of the invention will be described in detail below with reference to the drawings.

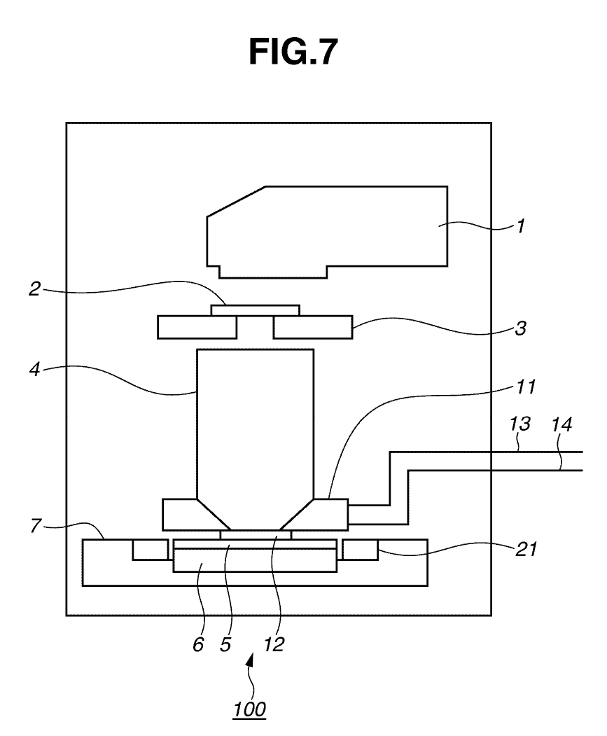

FIG. 7 is a schematic diagram illustrating an example of an exposure apparatus according to an exemplary embodiment of the present invention. An exposure apparatus 100 of the exemplary embodiment is an immersion exposure apparatus exposing a wafer (substrate) 6 to light via an immersion liquid 12. As illustrated in FIG. 7, the exposure apparatus of the exemplary embodiment includes an illumination device 1, a reticle stage 3, a projection optical system 4, a wafer stage 7, and a nozzle unit 11.

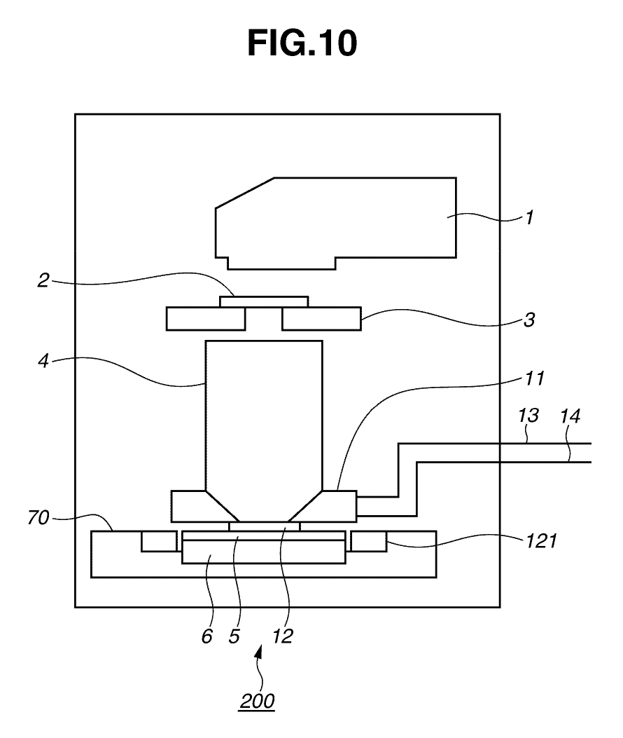

The exposure apparatus 100 of the exemplary embodiment is similar to the conventional exposure apparatus 200 illustrated in FIG. 10, but only a configuration of the wafer stage 7 is different. Therefore, the exemplary embodiment of the wafer stage 7 will be described in detail below.

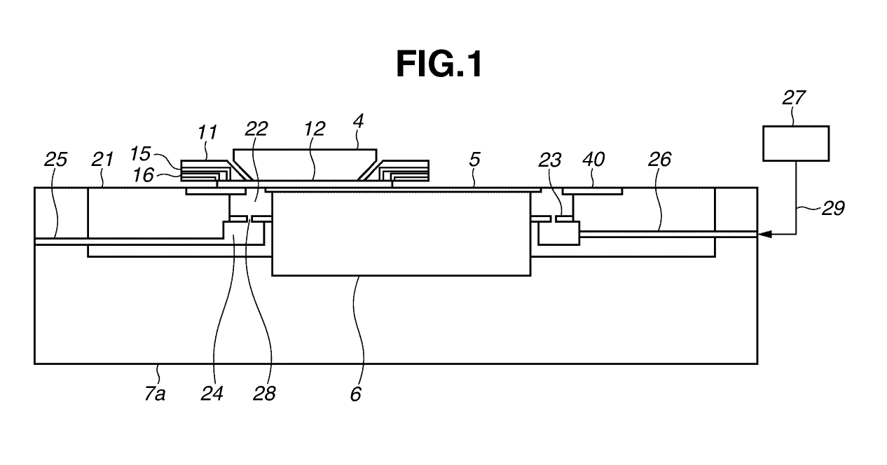

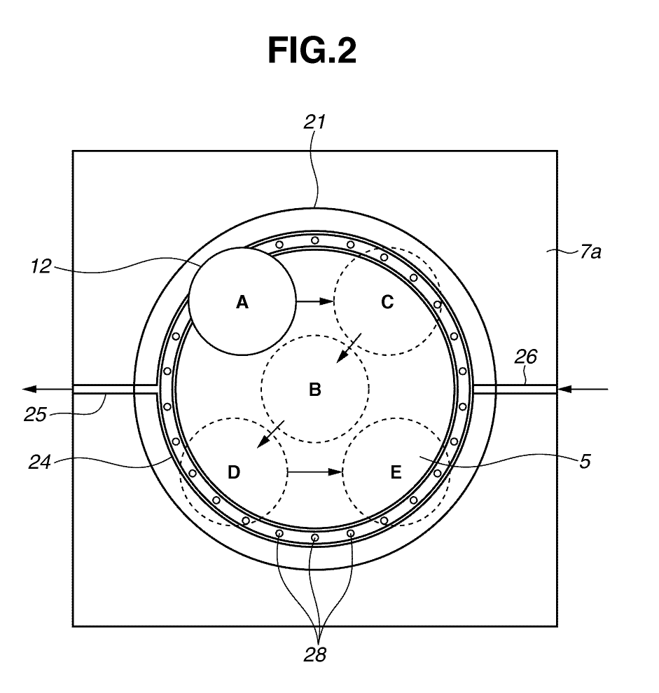

A wafer stage of the first exemplary embodiment will be described with reference to FIGS. 1 and 2. FIG. 1 is a cross-sectional view of the wafer stage according to the first exemplary embodiment of the present invention. FIG. 2 is a top view of the wafer stage according to the first exemplary embodiment of the present invention.

A wafer stage 7a of this exemplary embodiment includes a wafer chuck 6 and a support plate 21, as illustrated in FIG. 1. The wafer chuck 6 holds the wafer 5 by vacuum suction.

The support plate 21 is arranged around the wafer chuck 6, and supports the immersion liquid 12 and the wafer 5 when an edge shot of the wafer 5 is exposed to light. Thus, the surface of the support plate 21 is set at approximately the same height as the surface of the wafer 5 held by the wafer chuck 6.

The support plate 21 includes an annular interchangeable plate 40. The interchangeable plate 40 is detachably placed at a contact portion of the support plate 21 and the immersion liquid 12. The interchangeable plate 40 is interchanged when the interchangeable plate 40 is soiled.

The wafer stage 7a includes a recovery path and a temperature-regulating path 26. The recovery path includes a buffer space 22, a recovery space 24, and a recovery pipe 25. The immersion liquid 12 having entered a gap between the wafer 5 and the support plate 21 (the interchangeable plate 40) flows in the recovery path.

The nozzle unit 11 includes a supply port 15 and a recovery port 16. The supply port 15 supplies the immersion liquid 12 to between the projection optical system 4 and the wafer 5. The recovery port recovers the immersion liquid 12 from between the projection optical system 4 and the wafer 5.

As illustrated in FIG. 1, when the edge shot of the wafer 5 is exposed to light, the immersion liquid 12 exists on the gap between the support plate 21 and the wafer 5. A part of the immersion liquid 12 on the gap enters the gap, and drops to the buffer space 22.

The immersion liquid 12 pooling in the buffer space 22 passes through an aperture 28 of a partition plate 23, and flows in the recovery space 24. The immersion liquid 12 having flowed in the recovery space 24 flows into the recovery pipe 25. The recovery pipe 25 is connected with a suction pump (vacuum pump) (not illustrated), and the immersion liquid 12 is discharged from the exposure apparatus 100.

The buffer space 22 and the recovery space 24 are formed annularly to surround the circular chuck 6. The partition plate 23 for making a pressure difference is arranged between the buffer space 22 and the recovery space 24. A plurality of annular apertures 28 is formed on the partition plate 23 at predetermined intervals, and penetrate the partition plate 23.

A shape of the aperture 28 can be a circular shape or a slit shape, as illustrated in FIG. 2. A porous member can be fit to the aperture 28, and a material of the partition plate 23 can be a porous member without forming the aperture 28. In addition, the partition plate 23 is formed annularly to surround the chuck 6.

The positional relationship between the wafer stage 7a and the immersion liquid 12 (the projection optical system 4) when the wafer 5 is exposed to light will be described with reference to FIG. 2.

As illustrated in FIG. 2, the immersion liquid 12 relatively moves to the wafer stage 7a in order from an area A to an area C, from the area C to an area B, from the area B to an area D, and from the area D to an area E by moving the wafer stage 7a, and a plurality of shots on the wafer 5 are thus sequentially exposed to light.

When the immersion liquid 12 exists in the area A, the immersion liquid 12 exists on the gap between the wafer 5 and the support plate 21. At this time, the immersion liquid 12 enters the gap under the area A, and the immersion liquid 12 is supplied to the recovery path (the buffer space 22, the recovery path 24, and the recovery pipe 25).

Similarly, when the immersion liquid 12 exists in the area C, the area D, or the area E, the immersion liquid 12 enters the gap under the area C, the area D, or the area E, and the immersion liquid 12 is supplied to the recovery path.

However, when the immersion liquid 12 exists in the area B, the immersion liquid 12 does not exist on the gap between the wafer 5 and the support plate 21. Thus, the immersion liquid 12 is not supplied to the recovery path. When a state in which the immersion liquid 12 is supplied changes to a state in which the immersion liquid 12 is not supplied, the immersion liquid 12 adheres to a wall face of the recovery path and remains.

In such a state, when the suction pump (vacuum pump) continuously sucks, a gas flows on the surface of the immersion liquid 12 adhering to the wall face of the recovery path, and the evaporation of the immersion liquid 12 thus accelerates. Therefore, the temperature of the recovery path greatly lowers due to effect of the vaporization heat, and the temperature of the wafer stage 7a lowers.

Accordingly, while the wafer 5 is exposed to light, flowing of the immersion liquid 12 in the recovery path and not flowing therein are alternately repeated. Thus, the effect of the vaporization heat increases.

Therefore, in the wafer stage 7a of the present exemplary embodiment, the temperature-regulating path 26 is connected with the recovery space 24 of the recovery path, and the temperature-regulated liquid constantly flows in the recovery path. The temperature-regulated liquid, which is regulated at a predetermined temperature by a liquid temperature-regulating device 27, is supplied to the temperature-regulating path 26 through a temperature-regulated pipe 29.

The liquid temperature-regulating device 27 regulates a temperature of the temperature-regulated liquid so that the temperature of the temperature-regulated liquid is the same as the temperature of the immersion liquid 12, or higher than the temperature of the immersion liquid 12 considering the lowering of the temperature of the wafer stage 7a due to the vaporization heat. In addition, as for the temperature-regulated liquid, the same liquid as the immersion liquid 12 can be properly used.

In the wafer stage 7a of the present exemplary embodiment, the temperature-regulated liquid is constantly supplied to the recovery space 24. Thus, a liquid constantly flows in the recovery space 24 and the recovery pipe 25, and the liquid evaporation can be thus suppressed. As a result, the lowering of the temperature of the wafer stage 7a can be suppressed.

In the present exemplary embodiment, the temperature-regulating path 26 is connected with the recovery pipe 25 on the opposite side of the chuck 6. However, the temperature-regulating path 26 can be connected with any other position if the temperature-regulated liquid flows in the entire path of the recovery space 24.

The exposure apparatus 100 can suppress the liquid evaporation in the recovery pipe 25 by connecting the temperature-regulating path 26 to the recovery pipe 25 and supplying the temperature-regulated liquid from the recovery pipe 25, so that the lowering of the temperature of the wafer stage 7a can be suppressed

The temperature liquid can be supplied only when the immersion liquid 12 exists in the area B and does not exist on the gap between the wafer 5 and the support plate 21. Even when such a control is performed, the immersion liquid 12 or the temperature-regulated liquid constantly flows in the recovery path. Thus, the liquid evaporation in the recovery path can be suppressed, and the lowering of the temperature of the wafer stage 7a can be suppressed.

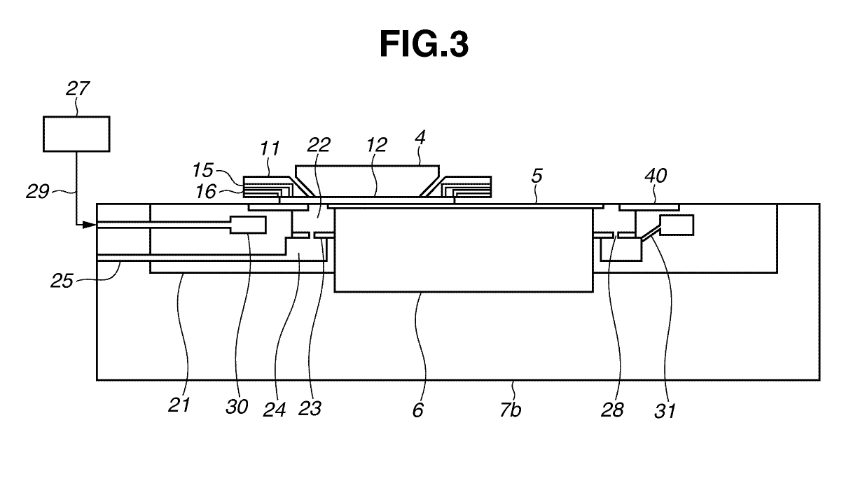

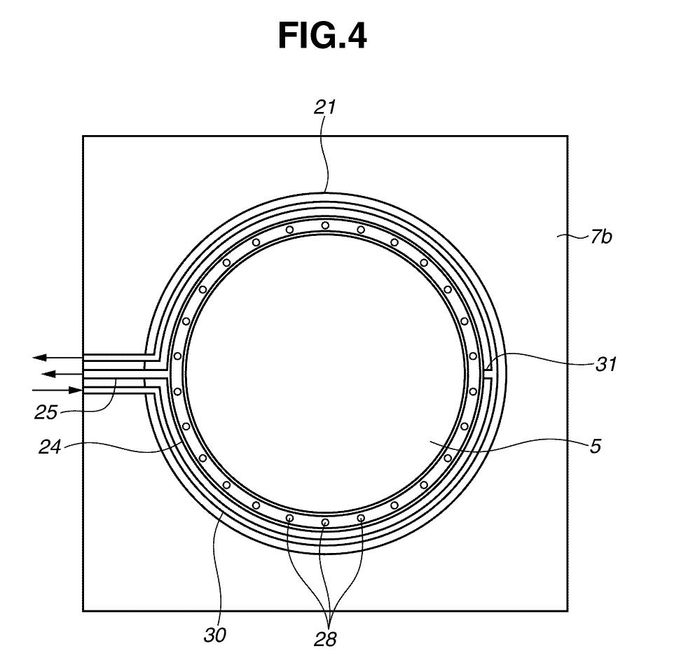

A wafer stage according to a second exemplary embodiment of the present invention will be described with reference to FIGS. 3 and 4. FIG. 3 is a cross-sectional view of the wafer stage of the second exemplary embodiment. FIG. 4 is a top view of the wafer stage of the second exemplary embodiment.

A wafer stage 7b of the present exemplary embodiment is different from the wafer stage 7a of the first exemplary embodiment about the point of including an annular temperature-regulating path 30 and connection path 31 in a support plate 21.

As illustrated in FIG. 4, the temperature-regulating path 30 is formed annularly to surround the wafer chuck 6. The liquid temperature-regulating device 27 supplies the temperature-regulated liquid, which is regulated at a predetermined temperature, to the temperature-regulating path 30 through the temperature-regulated pipe 29.

The temperature of the temperature-regulated liquid can be the same as a temperature of an immersion liquid 12, or can be higher than the temperature of the immersion liquid 12 considering the lowering of the temperature of the support plate 21 or the wafer stage 7b due to the vaporization heat.

The temperature-regulated liquid having flowed in the temperature-regulating path 30 goes around an inside of the support plate 21, and is discharged from the temperature-regulating path 30, as illustrated in FIG. 4.

The connection path 31 connects the temperature-regulating path 30 and the recovery space 24. A part of the temperature-regulated liquid flowing in the temperature-regulating path 30 can be constantly supplied to the recovery space 24 through the connection path 31 by providing the connection path 31.

Therefore, the temperature-regulated liquid supplied by the liquid temperature-regulating device 27 not only regulates the temperature of the support plate 21, but also suppresses the liquid evaporation in the recovery space 24 and the recovery pipe 25, and also suppresses the lowering of the temperature of the wafer stage 7b.

In the present exemplary embodiment, the connection path 31 connects the recovery space 24 and the temperature-regulating path 30. However, the connection path 31 can connect the recovery pipe 25 and the temperature-regulating path 30. Even when having such a configuration, the exposure apparatus 100 can regulate the liquid evaporation in the recovery pipe 25, and can suppress the lowering of the temperature of the wafer stage 7b.

Further, the connection path 31 can include a valve. The valve can supply the temperature-regulated liquid to the recovery path only when the immersion liquid 12 exists in the area B and does not exist on the gap between the wafer 5 and the support plate 21.

Furthermore, a plurality of connection paths 31 can be formed for connecting the recovery space 24 and the temperature-regulating path 30.

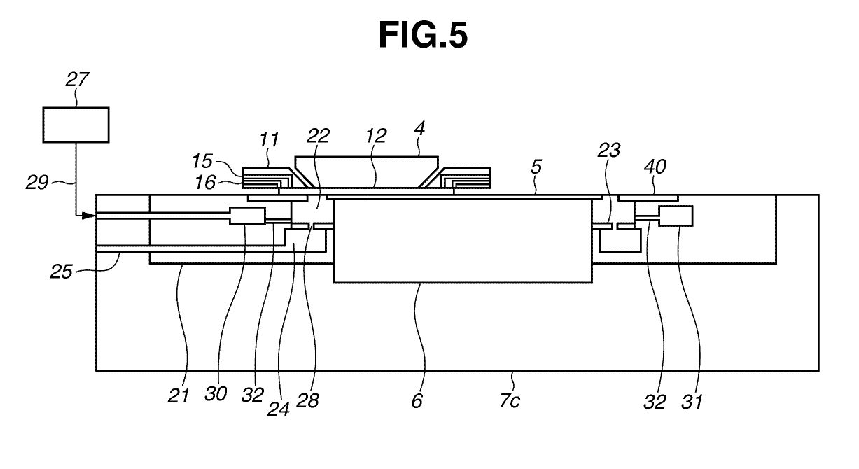

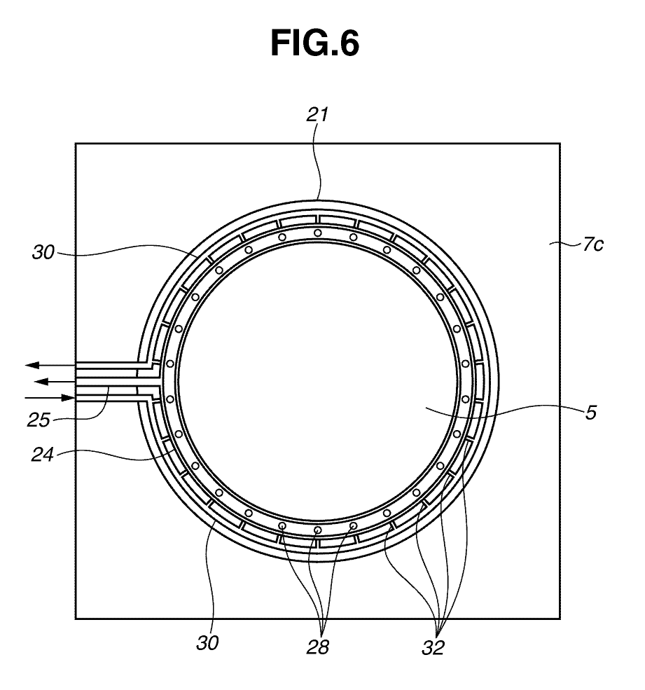

A wafer stage of a third exemplary embodiment will be described with reference to FIGS. 5 and 6. FIG. 5 is a cross-sectional view of a wafer stage of the third exemplary embodiment. FIG. 6 is a top view of the wafer stage of the third exemplary embodiment.

A wafer stage 7c of the present exemplary embodiment is different from the wafer stage 7b of the second exemplary embodiment about the point of including a connection path 32 instead of the connection path 31.

The connection path 32 connects the temperature-regulated pipe 30 and the buffer space 22. Apart of the temperature-regulated liquid in the temperature-regulating path 30 is constantly supplied to the buffer space 22 through the connection path 32 by providing the connection path 32.

Therefore, the temperature-regulated liquid supplied by the liquid temperature-regulating device 27 not only regulates the temperature of the support plate 21, but also suppresses the liquid evaporation in the buffer space 22, the partition plate 23, the recovery space 24, and the recovery pipe 25, and suppresses the lowering of the temperature of the wafer stage 7c.

As illustrated in FIG. 6, the connection path 32 includes a plurality of paths arranged corresponding to the positions of the plurality of the apertures 28. By having this configuration, a gas and a liquid constantly can flow in the plurality of the apertures 28, and thus the liquid evaporation in the recovery path, which is after the plurality of the apertures, can be suppressed.

In addition, the connection path 32 can include a valve. The valve can supply the temperature-regulated liquid to the recovery path only when the immersion liquid 12 exists in the area B and does not exist on the gap between the wafer 5 and the support plate 21.

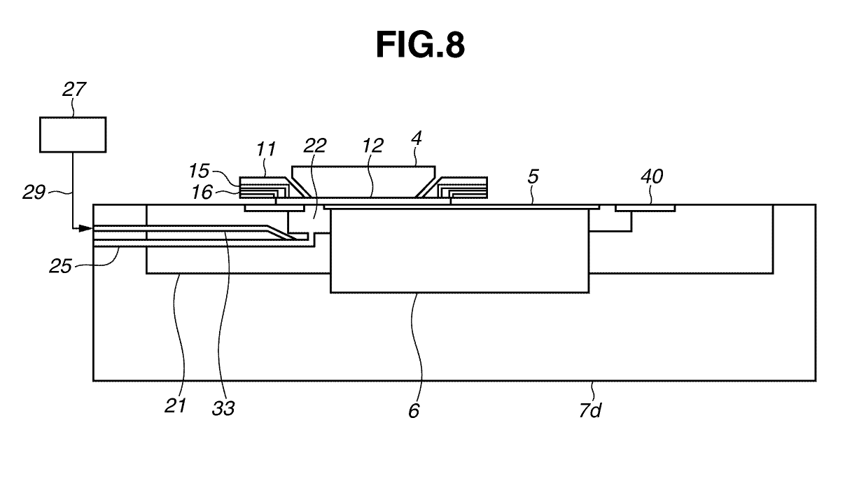

A wafer stage of a fourth exemplary embodiment of the present invention will be described with reference to FIG. 8. FIG. 8 is a cross-sectional view of the wafer stage of the fourth exemplary embodiment.

A wafer stage 7d of the present exemplary embodiment is different from the wafer stage 7a of the first exemplary embodiment about the points of including a temperature-regulating path 33 instead of the temperature-regulating path 26 and omitting the portion plate 23 and the recovery space 24 in the recovery path.

The liquid temperature-regulating device 27 supplies the temperature-regulated liquid, which is regulated at a predetermined temperature, to the temperature-regulating path 33 through the temperature-regulated pipe 29. The temperature-regulating path 33 is connected with the recovery pipe 25 of the recovery path.

By having this configuration, since the temperature-regulated liquid can be constantly supplied in the recovery pipe 25, sucking only a gas through the recovery pipe 25 is prevented. Thus, the exposure apparatus 100 can suppress the liquid evaporation, and can suppress the lowering of the temperature of the wafer stage 7d.

In the present exemplary embodiment, the temperature-regulating path 33 is connected with the recovery pipe 25. However, the temperature-regulating path 33 can be connected with the buffer space 22. By having this configuration, the exposure apparatus 100 can suppress the liquid evaporation in the buffer space 22 and the recovery pipe 25, and can suppress the lowering of the temperature of the wafer stage 7d. In this configuration, the temperature-regulating path 33 can include a plurality of paths, and the plurality of the paths can be connected with the buffer space 22.

The temperature-regulating path 33 can include a valve. The valve can supply the temperature-regulated liquid to the recovery path only when the immersion liquid 12 exists in the area B and does not exist on the gap between the wafer 5 and the support plate 21.

The wafer stage 7d can include an annular temperature-regulating path and connection path at the support plate 21. This configuration is similar to the configuration of the wafer stage 7b of the second exemplary embodiment.

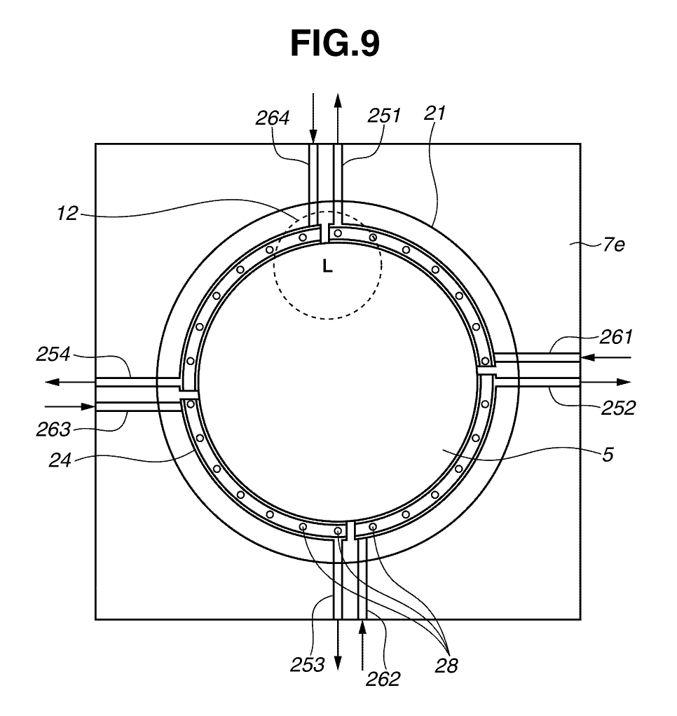

A wafer stage according to a fifth exemplary embodiment of the present invention will be described with reference to FIG. 9. FIG. 9 is a top view of the wafer stage of the fifth exemplary embodiment.

A wafer stage 7e of the present exemplary embodiment is different from the wafer stage 7a of the first exemplary embodiment about the point that both a temperature-regulating path and a recovery path is divided into two or more.

The wafer stage 7e includes four temperature-regulating paths 261 to 264, and four recovery paths. Therefore, the buffer space 22, the partition plate 23, and the recovery space 24 are also respectively divided into four. Each of recovery pipes 251 to 254 is connected with each of four recovery paths 24.

The temperature-regulating paths 261 to 264 are connected with the four recovery spaces 24 respectively.

When the immersion liquid 12 exists on the gap between the wafer 5 and the support plate 21 due to the movement of the wafer stage 7e, the immersion liquid 12 enters one or two of the four recovery paths. For example, as illustrated in FIG. 9, when the positional relationship between the wafer stage 7e and the immersion liquid 12 comes to be a relationship illustrated with L, the immersion liquid 12 enters two of the four recovery paths.

In such a case, the wafer stage 7e of the present exemplary embodiment recovers the liquid only by the recovery pipes 251 and 254, and does not recover the liquid by the other recovery pipes 252 and 253. Further, as for the temperature-regulated liquid, the wafer stage 7e supplies the temperature-regulated liquid only from the temperature-regulating paths 261 and 264, and does not supply the temperature-regulated liquid from the other temperature-regulating paths 262 and 263.

By having this configuration, since the temperature-regulated liquid is supplied to the recovery paths actually recovering the immersion liquid among the four recovery paths, sucking only a gas through the recovery paths is prevented. Therefore, the exposure apparatus 100 can suppress the liquid evaporation, and can suppress the lowering of the temperature of the wafer stage 7e. Since the recovery path is divided into four, the exposure apparatus 100 can spread the temperature-regulated liquid throughout each portion of the recovery paths, and can thus reduce an amount of the temperature-regulated liquid to be used.

Each of the recovery pipes 251 to 254 and each of the temperature-regulating paths 261 to 264 includes a valve. The wafer stage 7e recovers the immersion liquid 12 and supplies the temperature-regulated liquid by opening the valves of the recovery pipe and the temperature-regulating path, which are connected with the recovery space 24, which the immersion liquid 12 enters among the four recovery spaces 24. The valve is opened and closed by a controller (not illustrated) based on driving data of the wafer stage 7e.

In addition, in the present exemplary embodiment, the temperature-regulating paths 261 to 264 are connected with the recovery space 24. However, the temperature-regulating paths 261 to 264 can be connected with the buffer space 22 or the recovery pipes 251 to 254.

In the present exemplary embodiment, the wafer stage 7e includes the temperature-regulating paths 261 to 264 connected with each of four recovery paths. However, if the exposure apparatus 100 can be controlled to suck the immersion liquid 12 in the recovery path, where the immersion liquid 12 enters and flows, among the four recovery paths, the wafer stage 7e does not need to include the temperature-regulating paths 261 to 264.

Further, the wafer stage 7e can include an annular temperature-regulating path and connection path at the support plate 21, like the wafer stage 7b of the second exemplary embodiment.

Next, a method of manufacturing a device (semiconductor device, liquid crystal display device, etc.) as an embodiment of the present invention is described.

The semiconductor device is manufactured through a front-end process in which an integrated circuit is formed on a wafer, and a back-end process in which an integrated circuit chip is completed as a product from the integrated circuit on the wafer formed in the front-end process. The front-end process includes a step of exposing a wafer with a photoresist coated thereon to light using the above-described exposure apparatus of the present invention, and a step of developing the exposed wafer. The back-end process includes an assembly step (dicing and bonding), and a packaging step (sealing).

The liquid crystal display device is manufactured through a process in which a transparent electrode is formed. The process of forming a transparent electrode includes a step of coating a photoresist on a glass substrate with a transparent conductive film deposited thereon, a step of exposing the glass substrate with the photoresist coated thereon to radiant energy (light, x-ray, charged-particle beam, etc.) using the above-described exposure apparatus, and a step of developing the exposed glass substrate.

The device manufacturing method of this embodiment has an advantage, as compared with a conventional device manufacturing method, in at least one of performance, quality, productivity, and production cost of a device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-291104 filed Nov. 13, 2008, which is hereby incorporated by reference herein in its entirety.

What is claimed is:

1. An exposure apparatus for exposing a substrate to light via an immersion liquid, the apparatus comprising:
a stage configured to hold the substrate and to be moved, the stage including:
a chuck configured to hold the substrate;
a support member arranged around the chuck, and configured to support the immersion liquid;
a recovery path configured to recover the immersion liquid having entered a gap between the substrate and the support member; and
a temperature-regulating path through which a temperature-regulated liquid flows,
wherein the temperature-regulating path is connected with the recovery path.

2. An apparatus according to claim 1, wherein the temperature-regulating path is formed in the support member so as to surround the recovery path.

3. An apparatus according to claim 1, wherein the apparatus is configured such that the temperature-regulated liquid is supplied from the temperature-regulating path to the recovery path while the immersion liquid does not exist over the gap.

4. An apparatus according to claim 1, wherein the recovery path includes a buffer space formed so as to surround the chuck and configured to pool the immersion liquid having entered the gap, and a recovery pipe into which the immersion liquid flows from the buffer space, and
wherein the temperature-regulating path is connected with the recovery pipe.

5. An apparatus according to claim 1, wherein the recovery path includes a buffer space formed so as to surround the chuck and configured to pool the immersion liquid having entered the gap, and a recovery pipe into which the immersion liquid flows from the buffer space, and
wherein the temperature-regulating path is connected with the buffer space.

6. An apparatus according to claim 1, wherein the recovery path includes a buffer space formed so as to surround the chuck and configured to pool the immersion liquid having entered the gap, a recovery space which is formed so as to surround the chuck and into which the immersion liquid flows from the buffer space, a recovery pipe into which the immersion liquid flows from the recovery space, and an aperture member or a porous member configured to partition the buffer space and the recovery space.

7. An apparatus according to claim 6, wherein the temperature-regulating path is connected with the buffer space.

8. An apparatus according to claim 6, wherein the temperature-regulating path is connected with the recovery space.

9. The exposure apparatus according to claim 6, wherein the apparatus is configured such that the immersion liquid and the temperature-regulated liquid have a similar composition.

10. A method of manufacturing a device comprising:
exposing a substrate to light using an exposure apparatus;
developing the exposed substrate; and
processing the developed substrate to manufacture the device,
wherein the exposure apparatus exposes the substrate to light via an immersion liquid and includes:
a stage configured to hold the substrate and to be moved, the stage including:
a chuck configured to hold the substrate;
a support member arranged around the chuck, and configured to support the immersion liquid;
a recovery path configured to recover the immersion liquid having entered a gap between the substrate and the support member; and
a temperature-regulating path through which a temperature-regulated liquid flows,
wherein the temperature-regulating path is connected with the recovery path.
